(19) United States
(12) Patent Application Publication
(10) Pub. No.: US 2008/0028544 A1
(43) Pub. Date: Feb. 7, 2008

(54) Manufacturing Method of Three-Dimensional Cross-Linked Foam for Uppers of Shoes

(76) Inventor: Jang Won Park, Busan (KR)

Correspondence Address: BIRCH STEWART KOLASCH & BIRCH, PO BOX 747, FALLS CHURCH, VA, 22040-0747, US

(21) Appl. No.: 11/813,087

(22) PCT Filed: Apr. 21, 2005
(86) PCT No.: PCT/KR05/01142

§ 371 Date: Jun. 28, 2007

(30) Foreign Application Priority Data
Dec. 31, 2004 (KR) 10-2004-0117865

(51) Int. Cl. B29C 44/02

(52) U.S. Cl. 12/146 R

(57) ABSTRACT

The present invention provides a manufacturing method of three-dimensional cross-linked foam for uppers of shoes, comprising: preparing a plurality of foaming materials in a planar or three-dimensional shape with a cross-linked foaming suppressed; forming at least one interfacing pattern on at least one foaming material to prevent physical and chemical interactions between the foaming materials, the interfacing pattern formed of at least one interfacing material; cross-linked foaming of the foaming material having the interfacing pattern thereon to obtain a cross-linked foam in a planar shape, the cross-linked foam having at least one inner cavity structure therein; and vacuum molding the planar cross-linked foam in a vacuum molding die to obtain a cross-linked foam having a shape corresponding to a last, the planar cross-linked foam disposed in a cavity of the vacuum molding die, the cavity having a shape corresponding to the last.

### TECHNICAL FIELD

The present invention relates to a cross-linked foam, and more specifically a manufacturing method of three-dimensional cross-linked foam for uppers of shoes that has a shape corresponding to a last and has at least one inner cavity structure therein.

### BACKGROUND ART

The shoes that we usually wear for protecting the feet from the external circumstance mainly comprise soles and uppers. The uppers of the shoes directly contact the feet and thus increase a feeling of unity. Besides, the uppers play a primary role in protecting the feet from an external impact applied to the feet.

The uppers are usually formed using a last 10 that has a three-dimensional shape corresponding to completed uppers as shown in FIGS. 23 to 24. Because the last 10 has a three-dimensional shape and the raw material for the uppers are planar, a measurement of each portion of the last 10 must be taken and then converted to a measurement that can be applied to the planar raw material for the uppers such as cloth, leather and various resins, etc. That is, the last 10 has a three-dimensional measurement as shown in the figures in alphabet “a”, “b”, “c”, “d” and “e” and these measurement must be converted to a planar measurement that can be applied to the raw material for the uppers. The raw material is cut according to the converted measurement and then sewed or attached together. The sewed or attached material is put into close contact with the outer surface of the last 10 and then undergoes a heating and an ageing processes to obtain a completed uppers. The completed uppers acquired by the above-mentioned method have following disadvantages.

Firstly, many components of the completed uppers basically has a thin planar shape and is formed of soft material, a stability of a shape and a dimension is low compared with the soles of the shoes that is formed by a molding die. In addition, once the planar raw materials are transformed into a three-dimensional shape, it is difficult to keep the completed uppers in a three-dimensional shape.

Accordingly, this phenomenon is likely to happen to the uppers of the shoes when the shoes is repeatedly used for a certain period of time. To overcome this problem, an injection-molded material having a superior forming property and shape-maintenance property has been widely used for a specific component of the shoe at a certain portion of the uppers in the field. According to this method, the forming property and the shape-maintenance property of the uppers are greatly improved but a fitting feeling of the shoes may be lowered owing to the injection-molded material having a higher hardness than the cloth and the leather. Accordingly, the injection-molded material is limitedly used for a certain portion of the uppers or for shoes designed for a special purpose.

Secondly, because the uppers must primarily protect the feet from the external impact, it should have a supporting property and a good fitting. However, it has been very difficult for the uppers to satisfy those required properties because the uppers of the related art has been usually made of the thin, planar and soft materials. In an alternative to overcome the problem, various shock-absorbing material or protector may be put into the uppers or attached to the uppers during a sewing process. However, an applicable range of this method is very narrow considering that the upper is formed of thin planar material and has a smaller thickness than the soles of the shoe. Moreover, if several shock-absorbing materials having a relatively big volume are inserted or attached to a certain portion of the uppers, the fitting feeling between the uppers and the feet becomes bad and a naturally curved appearance of the shoes also becomes bad even though a shock-absorbing property of the certain portion of the uppers is improved.

Thirdly, recent customer has a preference to shoes that has a function of an air circulation and a waterproof to take a fresh air into the shoes and discharge sweat out of the shoes. However, it is not easy to give such properties to the uppers of the related art formed of the soft material such as leather. There are two different methods to provide the uppers with the function of air ventilation and waterproof. That is, a film or sheet type material for air ventilation and waterproof may be additionally attached to the uppers or a surface of the uppers may be chemically treated in order to fulfill the function of air ventilation and waterproof.

In case of the former, the film or the sheet having the function of air ventilation and waterproof is attached to a surface of the uppers or additional built-in uppers formed of the film or the sheet having the function of air ventilation and waterproof are formed in a shape of the sewed uppers and then put into the sewed uppers. However, this method makes the total manufacturing process of the shoes complex and accordingly increases the manufacturing cost.

In case of the latter, though the total process to treat the surface of the uppers chemically is relatively simple compared with the former, an effect of the air ventilation and waterproof is relatively poor considering that the chemical treatment is done only on the surface of the uppers.

### BRIEF DESCRIPTION OF DRAWINGS

The above and other objects, features and other advantages of the present invention will be more clearly understood from the following detailed description taken in conjunction with the accompanying drawings, in which:

FIG. 1 is a flow diagram illustrating a manufacturing process of a cross-linked foam according to the present invention;

FIG. 2 is a schematic diagram illustrating an interfacing pattern forming process and a cross-linked foaming process;

FIG. 3 is illustrating a perspective view of a cross-linked foam obtained by the cross-linked foaming process and a cross-sectional view taken along a line A-A′ of the perspective view;

FIG. 4 is a schematic diagram illustrating a vacuum molding process according to the present invention;

FIG. 5 is a front view of a cross-linked foam obtained by the vacuum molding process of FIG. 4;

FIG. 6 is a schematic view illustrating a processing of the cross-linked foam obtained by the vacuum molding process to obtain a three-dimensional cross-linked foam for uppers of shoes according to an embodiment of the present invention;

FIG. 7 is a schematic view illustrating a processing of the cross-linked foam obtained by the vacuum molding process to obtain a three-dimensional cross-linked foam for uppers of shoes according to another embodiment of the present invention;

FIG. 8 is a schematic view illustrating a re-molding of the cross-linked foam obtained by the vacuum molding process;

FIG. 9 is schematic view illustrating an injection process of a filler into an inner cavity structure in the three dimensional cross-linked foam;

FIG. 10 is schematic view illustrating an inserting process of a housing into an inner cavity structure in the three dimensional cross-linked foam;

FIG. 11 is illustrating a three-dimensional cross-linked foam for uppers of shoes according to an embodiment of the present invention;

FIGS. 12 to 13 are cross-sectional views of the three-dimensional cross-linked foam taken along lines B-B′ and C-C′ of FIG. 11, respectively;

FIG. 14 is a cross-sectional view of the three-dimensional cross-linked foam when the inner cavity structure of FIG. 12 is filled with filler;

FIG. 15 is a cross-sectional view of the three-dimensional cross-linked foam when the inner cavity structure of FIG. 13 is filled with filler;

FIG. 16 is a cross-sectional view of the three-dimensional cross-linked foam when a housing filled with filler is inserted into the inner cavity structure of FIG. 12;

FIG. 17 is illustrating a three-dimensional cross-linked foam for uppers of shoes according to another embodiment of the present invention;

FIGS. 18 to 19 are cross-sectional views of the three-dimensional cross-linked foam taken along lines D-D′ and E-E′ of FIG. 17, respectively;

FIG. 20 is illustrating a three-dimensional cross-linked foam for uppers for shoes according to another embodiment of the present invention;

FIGS. 21 to 22 are cross-sectional views of the three-dimensional cross-linked foam taken along lines F-F′ and G-G′ of FIG. 20, respectively; and

FIGS. 23 and 24 are illustrating a side and a bottom of a last.

### DISCLOSURE

### TECHNICAL PROBLEM

Accordingly, the present invention has been made keeping in mind the above problems occurring in the related art, and an object of the present invention is to provide a manufacturing method of three-dimensional cross-linked foam for uppers of shoes that can maintain a dimension and a shape for a long time because the cross-linked foam is formed according to a shape of a last.

Another object of the present invention is to provide a manufacturing method of three-dimensional cross-linked foam for uppers of shoes that can increase fitting feeling and supporting property of the shoes without attaching additional components to the uppers.

Another object of the present invention is to provide a manufacturing method of three-dimensional cross-linked foam for uppers of shoes that can naturally circulate air between the inside and outside of the shoes and have a proper function of waterproof.

Another object of the present invention is to provide a manufacturing method of three-dimensional cross-linked foam of uppers of shoes that can differentiate a hardness and design of each portion of the shoes.

### TECHNICAL SOLUTION

To achieve these and other advantages and in accordance with the purpose of the present invention, as embodied and broadly described, a manufacturing method of three-dimensional cross-linked foam for uppers of shoes comprises preparing a plurality of foaming materials in a planar or three-dimensional shape with a cross-linked foaming suppressed; forming at least one interfacing pattern on at least one foaming material to prevent physical and chemical interactions between the foaming materials, the interfacing pattern formed of at least one interfacing material; cross-linked foaming of the foaming material having the interfacing pattern thereon to obtain a cross-linked foam in a planar shape, the cross-linked foam having at least one inner cavity structure therein; and vacuum molding the planar cross-linked foam in a vacuum molding die to obtain a cross-linked foam having a shape corresponding to a last, the planar cross-linked foam disposed in a cavity of the vacuum molding die, the cavity having a shape corresponding to the last.

In the above, the method may further comprise putting the cross-linked foam into close contact with the last and processing the cross-linked foam into a shape of the last after the vacuum molding.

In the above, the method may further comprise following steps after the vacuum molding: putting the cross-linked foam into close contact with the last and disposing the cross-linked foam and the last in a re-molding die having a cavity; and re-molding the cross-linked foam, inner and outer surface of the re-molded cross-linked foam having shapes corresponding to an outer surface of the last and a surface of the cavity of the re-molding die, respectively.

In the above, the plural interfacing patterns may be formed on the foaming material.

In the above, all or some of the plural interfacing patterns may be connected to each other.

In the above, adjacent interfacing patterns among the plural interfacing patterns may be connected to each other.

In the above, the method may further comprise filling at least one of the inner cavity structure with a filler, the filler selected from gas, same material as or different material from the cross-linked foam after one of the cross-linked foaming and the vacuum molding.

In the above, the method may further comprise filling at least one of the inner cavity structure with a filler, the filler selected from gas, same material as or different material from the cross-linked foam after processing the cross-linked foam.

In the above, the method may further comprise filling at least one of the inner cavity structure with a filler, the filler selected from gas, same material as or different material from the cross-linked foam after one of disposing and re-molding the cross-linked foam.

In the above, the filler may be introduced into a housing and the housing is disposed in the inner cavity structure.

In the above, the method may further comprise forming at least one air passage connected to at least one inner cavity structure after one of the cross-linked foaming and the vacuum molding.

In the above, the method may further comprise forming at least one air passage connected to at least one inner cavity structure after processing the cross-linked foam.

In the above, the method may further comprise forming at least one air passage connected to at least one inner cavity structure after one of disposing and re-molding the cross-linked foam.

In the above, the cavity of the vacuum molding die may have a shape corresponding to one of fore-foot, middle-foot, rear-foot, inner side and outer side of the last.

In the above, unevenness may be formed on a surface of the cavity of the vacuum molding die to form unevenness on the cross-linked foam at a position corresponding to at least one of the inner cavity structure.

In the above, the cavity of the re-molding die may have a shape corresponding to one of fore-foot, middle-foot, rear-foot, inner side and outer side of the last.

In the above, unevenness may be formed on a surface of the cavity of the re-molding die to form unevenness on the cross-linked foam at a position corresponding to at least one of the inner cavity structure.

In the above, the foaming material may be a thin film type foaming material having a uniform surface roughness.

In the above, the thin film type foaming material may be obtained by processing a foaming material having a shape of a sheet or a pellet.

In another aspect, the present invention provides a manufacturing method of three-dimensional cross-linked foam for uppers of shoes that comprises preparing at least one foaming material in a planar or three-dimensional shape with a cross-linked foaming suppressed; cross-linked foaming of the foaming material to obtain a planar cross-linked foam; and vacuum molding the planar cross-linked foam in a vacuum molding die to obtain a cross-linked foam having a shape corresponding to a last, the planar cross-linked foam disposed in a cavity of the vacuum molding die, the cavity having a shape corresponding to the last.

In the above, the method may further comprise putting the cross-linked foam into close contact with the last and processing the cross-linked foam into a shape of the last after the vacuum molding.

In the above, the method may further comprise following steps after the vacuum molding: putting the cross-linked foam into close contact with the last and disposing the cross-linked foam and the last in a re-molding die having a cavity; and re-molding the cross-linked foam, inner and outer surface of the re-molded cross-linked foam having shapes corresponding to an outer surface of the last and a surface of the cavity of the re-molding die, respectively.

In the above, the method may further comprise forming at least one air passage at the cross-linked foam after one of the cross-linked foaming and the vacuum molding.

In the above, the method may further comprise forming at least one air passage at the cross-linked foam after processing the cross-linked foam.

In the above, the method may further comprise forming at least one air passage at the cross-linked foam after one of disposing and re-molding the cross-linked foam.

In the above, the cavity of the vacuum molding die may have a shape corresponding to one of fore-foot, middle-foot, rear-foot, inner side and outer side of the last.

In the above, unevenness may be formed on a surface of the cavity of the vacuum molding die to form unevenness on the cross-linked foam.

In the above, the cavity of the re-molding die may have a shape corresponding to one of fore-foot, middle-foot, rear-foot, inner side and outer side of the last.

In the above, unevenness may be formed on a surface of the cavity of the re-molding die to form unevenness on the cross-linked foam.

In the above, the foaming material may be a thin film type foaming material having a uniform surface roughness.

In the above, the thin film type foaming material may be obtained by processing a foaming material having a shape of a sheet or a pellet.

It is to be understood that both the foregoing general description and the following detailed description are exemplary and explanatory and are intended to provide further explanation of the invention as claimed.

### ADVANTAGEOUS EFFECT

According to the present invention, because the cross-linked foam for uppers of shoes is formed in a three-dimensional shape according to the shape of the last having a complex curved surface so that dimension and shape stabilities can be provided to the shoes.

Because the cross-linked foam of the present invention has at least one inner cavity structure therein formed simultaneously with the cross-linked foam and the inner cavity may have gas therein at a certain pressure, fitting feeling and supporting property is greatly improved.

The cross-linked foam of the present invention can provide air ventilation and waterproof properties to the shoes so that air in the shoes can effectively discharged out of the shoes while moisture can not permeates the shoes.

The cross-linked foam of the present invention can provide required physical property to each portion of the shoes without an additional cutting and sewing process by filling various materials in inner cavity structures formed in the cross-linked foam.

### MODE FOR INVENTION

Reference will now be made in detail to the preferred embodiment of the present invention, which is illustrated in the accompanying drawings. A same name will be used for an element of the present invention that has a same or corresponding function even if it has a different reference number.

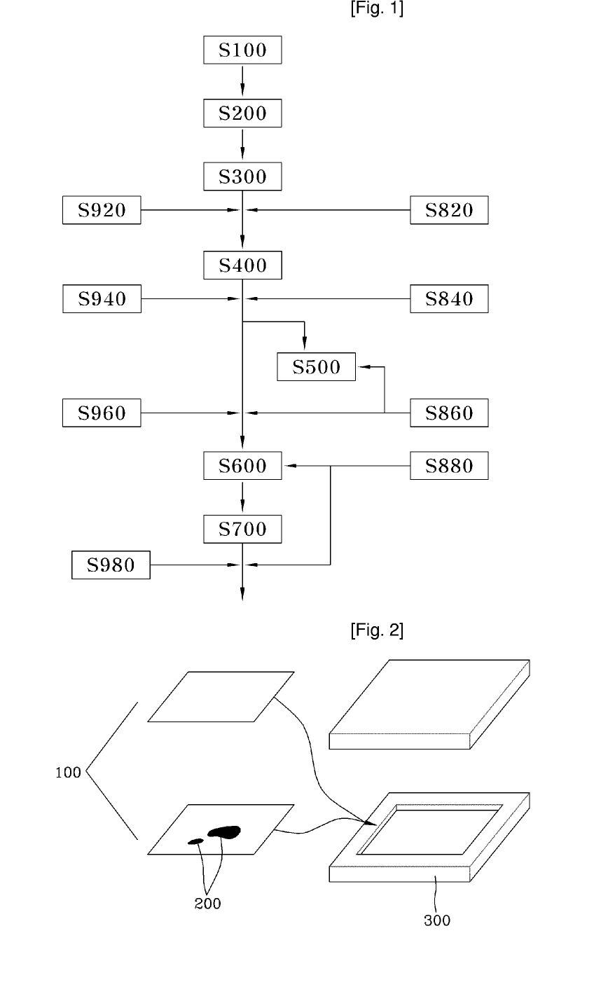

FIG. 1 is a flow diagram illustrating a manufacturing process of a cross-linked foam according to the present invention. The present invention mainly comprises steps of preparing foaming material (S100), forming an interfacing pattern (S200), cross-linked foaming (S300) and vacuum molding (S400).

In the step S100, a source material for the foaming material is selected from various materials considering a use and a physical property of the cross-linked foam. After planning the material composition, the source material and the sub materials are weighed by desired amounts in accordance with the material composition plan, and then the source material and sub materials are mixed in the properly selected mixing device. The mixed chemical compound is then processed in a foaming material with a cross-linked foaming suppressed by a calender or an extruder.

The source material used in the step S100 can be selected from a synthetic material having a possibility to become a foam using a various cross-linked foaming method, for example, synthetic resins such as an EVA based resin, a polyolefin based resin containing PEs of a variety of densities, a polyvinyl based resin, a polyurethane based resin, and LDPE(low density polyethylene)-added EVA, a copolymer thereof, a blend thereof, or a mixture thereof; a natural or synthetic rubber constituted by a mixture of a natural rubber, a styrene butadiene rubber (SBR) based, a poly-butadiene rubber(BR) based, an poly-isoprene rubber(IR) based, a chloroprene rubber(CR) based, an nitrile rubber (NBR) based, an EPDM rubber based, an ethylene-propylene rubber(EPR) based, and an acryl rubber (AR) based rubber, and/or an styrene butadiene rubber(SBR) added neoprene rubber(NR); and a composite material including an EPDM rubber added ethylene-vinyl acetate (EVA) and a poly-vinyl chloride (PVC) added nitrile rubber (NBR).

However, it is recommended to adopt EVA (ethylene-vinyl acetate) that can contain a variable percentage of an amount of vinyl acetate (VA %) or the polyethylene (PE) based synthetic resin having various densities as the source material.

The foaming material has a planar shape, such as film or sheet, or a three-dimensional shape, such as pellet. The foaming material according to the present invention is not limited to a specific shape or type, but the foaming material is weighed at every foaming process if a foaming material of a particle or sheet type is used. Further, when the foaming material is applied to the specific embodiment, the foaming material is recommended to have a plane shape, particularly a film shape, which has a low surface roughness, regarding the advisable use. If the obtained foaming material has a shape such as the pellet or the sheet having a rough surface, it may desirably be re-processed into a thin film having a low surface roughness. However, the shape of the foaming material is not limited as long as it can be processed into a certain shape with the cross-linked foaming suppressed and an interfacing pattern can be formed thereon later in the process.

In the step S200, at least one interfacing pattern is formed on the foaming material with different material from the foaming material to prevent a physical and chemical action among particles of the foaming materials.

The material for the interfacing pattern may be liquid having a viscosity, powder or solid having a certain shape such as films as long as it is able to prevent the interaction between the foaming materials during the cross-linked foaming process. For example, the interfacing material may be selected from a group consisting of natural or synthetic paints or inks, natural or synthetic resins, papers, textiles, non-woven fabrics, and rubbery materials. Additionally, when selecting the interfacing material, it is considerable to be easily attached to the foaming material, to have the repeated reappearance during the foaming process, to have the possibility of obstructing the cubical expansion of the foam during the foaming process, or to have the easy elimination from the cross-linked foam if required after the foaming process.

The formation of the interfacing pattern may be achieved by printing, transcription, coating, deposition, lamination, spray, cloth attachment, inserting, attaching or a modification thereof, and any other method can be possible only if it is able to form the interfacing material on the surface of the foaming material. However, when the ink or the like containing various kind of resins dissolved is used as an interfacing material, the printing method is desirably adopted in forming the interfacing pattern.

Further, if more than two interfacing patterns are formed, each of the interfacing patterns may be formed with same or different material. A foaming agent, which is the same as or different from a foaming agent contained in the foaming material, may be added to the interfacing material.

Moreover, a step of combining a foaming material having no interfacing pattern with the foaming material having the interfacing pattern may be further added. The foaming material having no interfacing pattern may be the same material as or different material from the foaming material having the interfacing pattern. A step of adding material same as or different from the foaming material having the interfacing pattern to the combined foaming material may be further added.

A plurality of interfacing patterns may be formed without a connection to each other, or all or some of the plural interfacing patterns may be connected to each other. Besides, the interfacing pattern may be connected only to the neighboring interfacing patterns to form a group of connected interfacing patterns.

In FIG. 2, two sheets of foaming material 100 are prepared and the interfacing pattern 200 is formed on one of two sheets of foaming materials 100.

In the step S300, the cross-linked foam having a planar shape is formed by cross-linked foaming the foaming material having the interfacing pattern thereon. The cross-linked foaming of the foaming material may be performed by one of a pressure cross-linked foaming method and normal pressure cross-linked foaming method but the cross-linked foaming method is not confined to those. In FIG. 2, a press type method using a molding die 300 is selected as one of the pressure cross-linked foaming methods.

If the heat is applied to the foaming material or if the electron rays are irradiated on the foaming material during the cross-linked foaming process, the foaming material is cross-linked in a gel state by the heat infliction or the electron irradiation. However, the foaming materials neighboring each other across the interfacing pattern are not physically/chemically coupled and interconnected until they reach the step of foaming. At this state, the foaming materials cubically expand at a specific rate and then the cross-linked foams are made.

Portions of the foaming materials corresponding to the interfacing patterns 200 are also cubically expanded at the similar ratio as the other portions during the foaming process. However, because the physical and chemical connection of the foaming material is prevented by the interfacing pattern 200, an empty space 326 formed by an internally-formed surface is formed in the cross-linked foam 320 at a position corresponding to the interfacing pattern 200.

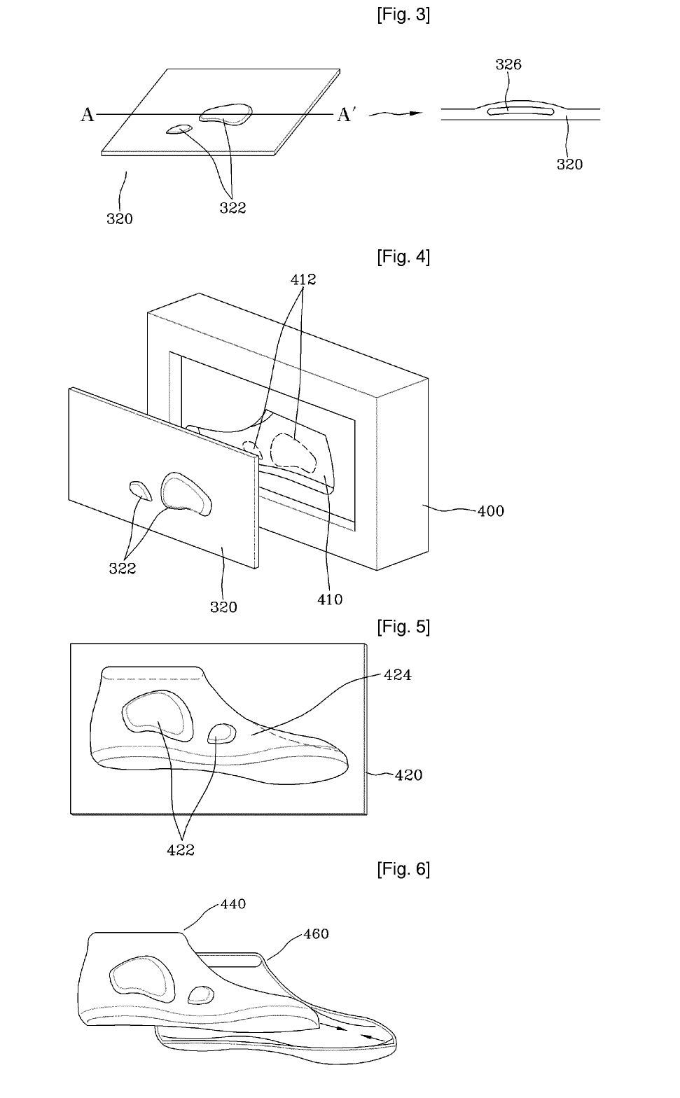

As shown in FIG. 3 illustrating a perspective view of a cross-linked foam obtained by the cross-linked foaming process and a cross-sectional view taken along a line A-A′ of the perspective view, the inner cavity structures 326 is formed in the cross-linked foam 320. Gases such as nitrogen (N₂) and carbon dioxide (CO₂) that is generated by a decomposition action of the foaming agent during the foaming process is trapped in the inner cavity structure 326 and thus keep the interior of the inner cavity structure 326 at a certain pressure.

The inner cavity structure 326 is formed simultaneously with the cross-linked foam 320 and is formed naturally according to the shape of the cross-linked foam 320. The inner cavity structure 326 can function as a shock-absorbing means so that it increases supporting property and shape stability. Besides the inner cavity structure 326 improves a fitting feeling between the cross-linked foam and the feet and effectively protects the feet from an external conditions.

The interior pressure of the gases in the inner cavity structure 326 can be properly controlled by adding a foaming agent to the interfacing material before the cross-linked foaming process. The unexplained reference number 322 is a covering portion of the inner cavity structure.

The shape and structure of the inner cavity structure 326 can be modified diversely by controlling shapes of the interfacing patterns or changing interfacing materials regardless of shapes and kinds of the tools and devices for the cross-linked foaming process such as a molding die.

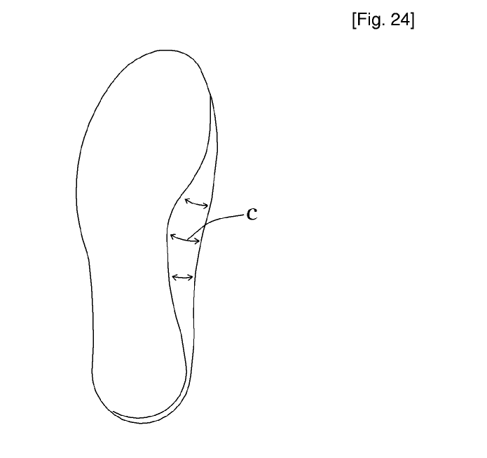

In the step S400, the planar cross-linked foam 320 having the inner cavity structure 326 is disposed in a vacuum molding die and molded using a vacuum pressure. A cavity of the vacuum molding die may desirably have a shape of a last having a curved surface. The cavity of the vacuum molding die may desirably have a shape correspond to fore-foot “a”, middle-foot “b” and “c” or rear-foot “d” of the last 10 as shown in FIGS. 23 and 24.

Unevenness may desirably be formed in a surface of the cavity of the vacuum molding die at a position corresponding to the projected covering portion of the inner cavity structure. Though a shape of the unevenness of the cavity of the vacuum molding die may be a little different from the projected covering portion of the inner cavity structure, it is more desirable that it have a same shape as the covering portion of the inner cavity structure. Unevenness may further be formed on the cavity of the vacuum molding die at a position that does not correspond to the inner cavity structure and this unevenness forms additional unevenness on the surface of the cross-linked foam other than the surface of the covering portion of the inner cavity structure.

FIG. 4 is a schematic diagram illustrating a vacuum molding process according to the present invention. The cavity 410 of the vacuum molding die 400 has a shape corresponding to a outer side of the last 10 and has unevenness 412 corresponding to the covering portion 322 of the inner cavity structure 326. In an alternative, the cavity 410 may have a shape corresponding to one of fore-foot, middle-foot, rear-foot, inner side, outer sides and other portions of the last 10.

Though it is not shown in figures, unevenness may further be formed on the cross-linked foam 320 at a position corresponding to an instep of fore-foot to which a repeated bending stress is applied and to a heel portion that should protect the feet from an external impact.

A softening process may be performed to the planar cross-linked foam by a heating means such as a heater before disposing the cross-linked foam in the vacuum molding, which will facilitate the forming process in the vacuum molding die.

Once the vacuum molding process is finished, the planar cross-linked foam 320 of FIG. 4 is transformed to a three-dimensional cross-linked foam 420 of FIG. 5 having a surface portion 424 and the covering portion 422 of a three-dimensional shape. The present invention may further have a processing step S500 in which the cross-linked foams obtained by the vacuum molding process are cut and then sewed or adhered and then cut to obtain completed uppers of shoes having a three-dimensional shape.

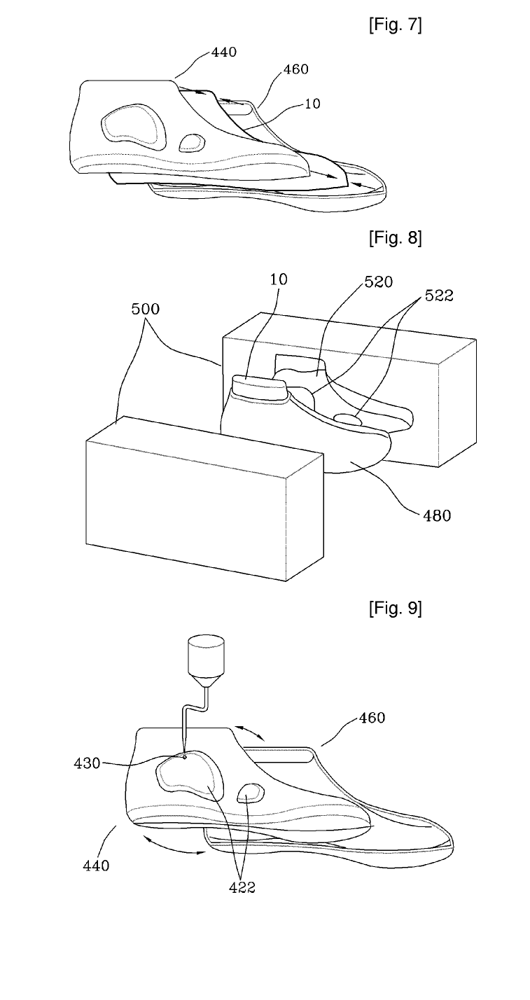

As shown in FIG. 6 and 7, the cross-linked foam 440 and 460 obtained after the vacuum molding process are assembled to produce the completed uppers. This assembling process may desirably be performed with the cross-linked foam 440 and 460 put into close contact with the last 10 considering an efficiency of assembling process and stability of the shape.

FIG. 11 is illustrating a three-dimensional cross-linked foam for uppers obtained by forming two interfacing patterns on the foaming material and then cross-linked foaming and vacuum molding the foaming material. FIG. 12 is cross-sectional view of the three-dimensional cross-linked foam taken along a line B-B′ of FIG. 11. As shown in the figures, the completed uppers 600 for shoes is formed of the three-dimensional cross-linked foam 620 having the inner cavity structure 642. An inner surface 680 of the completed uppers 600 is formed according to the outer curved surface “b” and “c” of the last 10 in FIGS. 23 and 24.

The present invention may further include a step of re-molding the cross-linked foam after the vacuum molding step S400. The re-molding step may desirably comprise a step S600 of disposing the cross-linked foam in a re-molding die and a step S700 of closing the re-molding die and then re-molding the cross-linked foam.

In the step S600, the three-dimensional cross-linked foam obtained by the vacuum molding is put into close contact with the last and then disposed in a cavity of the re-molding die. The cavity of the re-molding die may desirably have a shape corresponding to the last.

Unevenness may desirably be formed in a surface of the cavity of the re-molding die at a position corresponding to the projected covering portion of the inner cavity structure. Though a shape of the unevenness of the cavity of the re-molding die may be a little different from the projected covering portion of the inner cavity structure, it is more desirable that it have a same shape as the covering portion of the inner cavity structure.

Unevenness may further be formed on the cavity of the re-molding die at a position that does not correspond to the inner cavity structure and this unevenness forms additional unevenness on the surface of the cross-linked foam other than the surface of the covering portion of the inner cavity structure.

In the step S700, the re-molding die is closed and then heated so that inner and outer surfaces of the cross-linked foam with the last therein has shapes corresponding to the curved outer surface of the last and the surface of the cavity of the re-molding die, respectively. Once the re-molded cross-linked foam is separated from the last after the step S700, a shape of the three-dimensional cross-linked foam becomes more close to the last.

In FIG. 8, the cross-linked foam 480 with the last 10 therein is being inserted in the cavity 520 of the re-molding die 500. The cavity 520 of there-molding die 500 has a shape corresponding to inner side and outer side and has unevenness 522 corresponding to the inner cavity structure of the cross-linked foam 480. In an alternative, the cavity 520 of the re-molding die 500 may have a shape corresponding to one of fore-foot, middle-foot, rear-foot and other portions of the last.

When the three-dimensional cross-linked foam for uppers of shoes is obtained, a step of forming an air passage connected to at least one of the inner cavity structure may be added to the manufacturing process of the present invention. The air passage may be formed after the step of cross-linked foaming S300, or before or after one of the steps of vacuum molding S400, processing S500, disposing S600 and re-molding S700 as shown in S920, S940, S960 and S980 of FIG. 1, considering that the air passage is connected to the inner cavity structure.

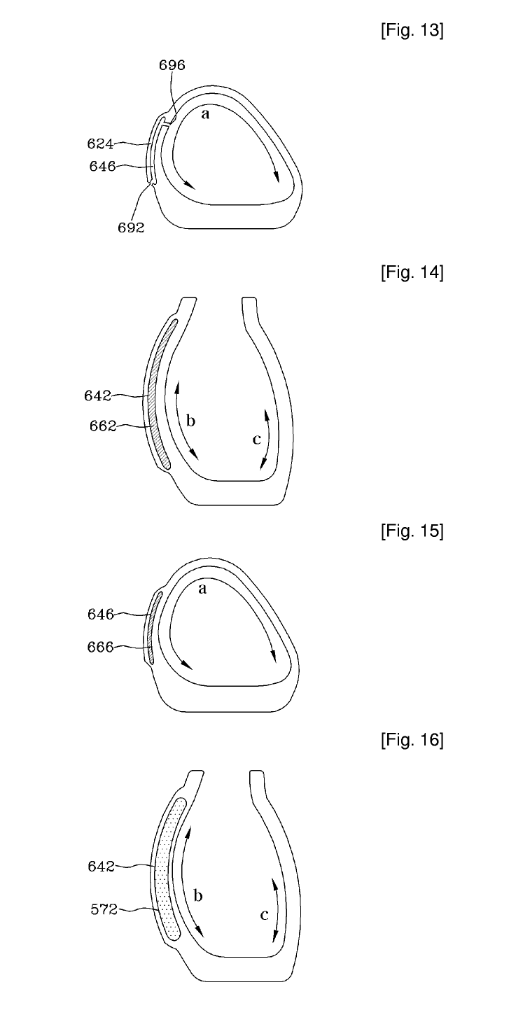

In FIG. 13 illustrating a cross-sectional view of the cross-linked foam of FIG. 11 taken along a line C-C′, inner and outer air passages 696 and 692 connected to the inner cavity structure 646 are formed in the three-dimensional cross-linked foam for uppers of shoes having an inner surface formed faithfully along the outer surface “a” of the last. Because the covering portion 624 is formed simultaneously with the cross-linked foam in a unity during the cross-linked foaming step S300, the dimension and shape stabilities can be guaranteed for a long time although the air passage 692 and 696 are formed on the cross-linked foam.

A waterproof function can be provided to the cross-linked foam by controlling relative positions of the inner and outer air passages 696 and 692. The air passages discharge moisture in the cross-linked foam and prevent moisture in the outside from infiltrating into the cross-linked foam. The position and number of the air passages can be changed depending on the condition and is not limited. A valve may be connected to the air passage to control an amount of the air flowing in and out of the air passages.

The present invention may further comprise a step of forming a hole in at least one of the inner cavity structure and then injecting filler into the inner cavity structure. Because the inner cavity structure has gases such as nitrogen (N₂) and carbon dioxide (CO₂) generated during the cross-linked foaming step, the inner cavity structure has superior properties such as shock-absorbing power and elastic force. However, such properties may further be increased by filling at least one of the inner cavity structures with one of gas selected from various gases or material that is same as or different from the cross-linked foam. The filler may be selected from various materials in a phase of gas, liquid or solid and may be a molded material having a certain shape.

The injecting step can be performed after the step of cross-linked foaming S300, or before or after one of the steps of vacuum molding S400, processing S500, disposing S600 and re-molding S700.

In FIG. 9, an injection hole 430 is formed at the covering portion 422 and then the filler is injected into the inner cavity structure using an injection device. FIGS. 14 and 15 illustrate cross-sections of the cross-linked foam of which the inner cavity structure 642 and 646 are filled with filler 662 and 666.

In an alternative, the filler may be firstly injected into a housing and the housing may be inserted into the inner cavity structure so that the filler can be effectively introduced into the inner cavity structure regardless of a phase and a shape of the filler. The housing filled with the filler may be introduced into the inner cavity structure or an empty housing may be introduced into the inner cavity structure and then filled with the filler. Once the housing is filled with the filler, the housing must be sealed. Though a material of the housing is not limited as long as the filler can be properly positioned in the inner cavity structure, it may desirably be thermoplastic polyurethane (TPU) widely used for various housing. The injection process of the filler may be performed at anytime after the cross-linked foaming step during which the inner cavity structure is formed.

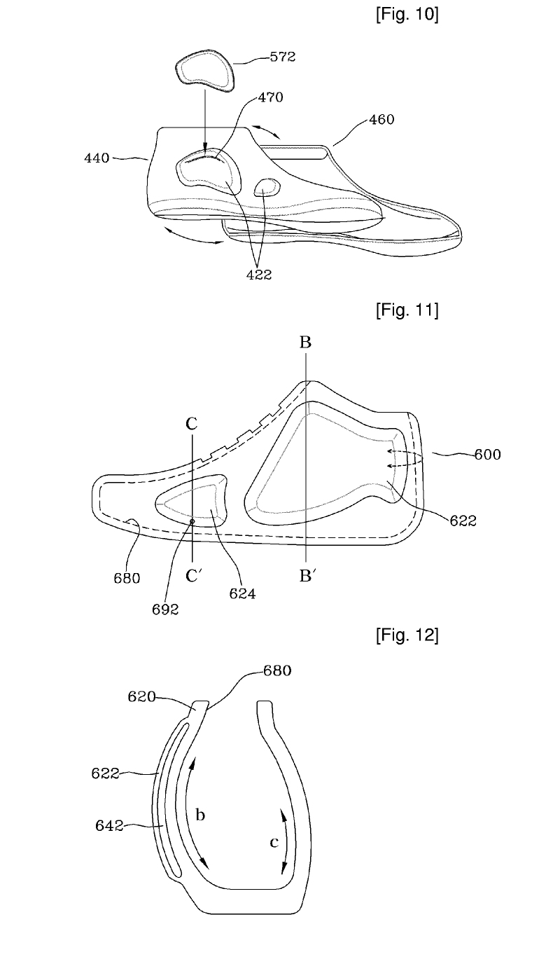

In FIG. 10, an incised portion 470 is formed at one of the covering portions 422 of the inner cavity structure and then the housing 572 filled with the filler is inserted into the inner cavity structure. The FIG. 16 illustrates a cross-section of the cross-linked foam for uppers of which the inner cavity structure contains the housing filled with the filler.

The three-dimensional cross-linked foam for uppers of shoes may go through additional processes in which various decorations, cloth and leather are added to the cross-linked foam. However, because these following processes are well known in the field, more details about those processes will not be described hereinafter.

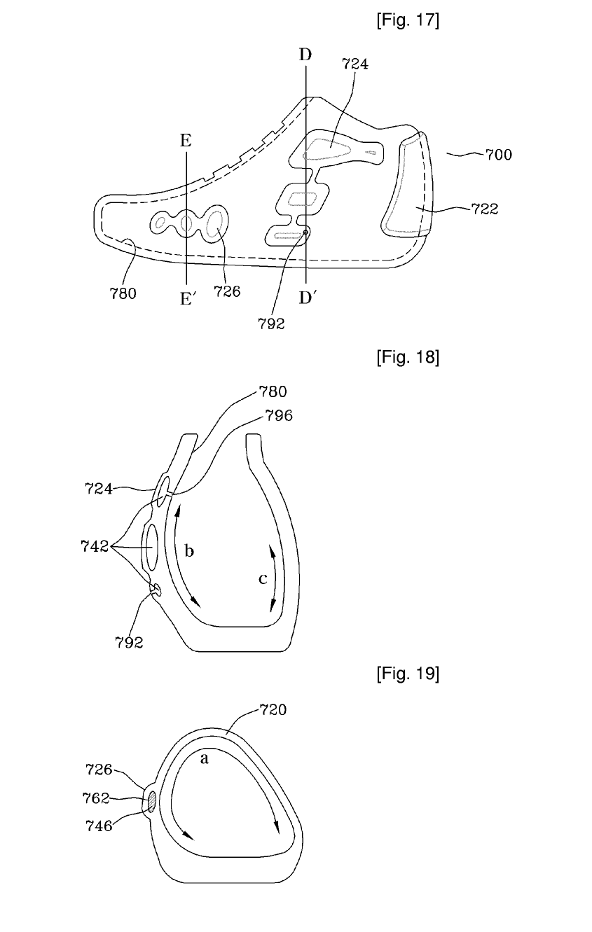

FIG. 17 is illustrating a three-dimensional cross-linked foam for uppers for shoes according to another embodiment of the present invention and FIGS. 18 to 19 are cross-sectional views of the three-dimensional cross-linked foam taken along lines D-D′ and E-E′ of FIG. 17, respectively. The uppers 700 mainly have three inner cavity structures that are formed by forming three different interfacing patterns at different positions of the foaming material. Reference numbers 722, 724 and 726 are covering portions of each of the inner cavity structures, respectively. Inner cavities in the inner cavity structure 742 and 762 respectively are connected to each other as shown in the figures. The inner and outer air passages 796 and 792 are connected to the inner cavity structure 742 as shown in FIG. 18 and the inner cavity structure 762 is filled with the filler 746 as shown in FIG. 19.

According to this embodiment, the fitting feeling and the supporting property of the three-dimensional cross-linked foam for uppers can be effectively increased by forming the inner cavity structure at a certain portion of the cross-linked foam and introducing various materials having a required property into each of the inner cavity structures. Besides, the three-dimensional cross-linked foam for uppers can have an air ventilating function by forming the air passage selectively at the inner cavity structure. The three-dimensional cross-linked foam for uppers can have a waterproof function by controlling positions of the air passages so that the air can freely circulates in and out of the uppers while the moisture cannot infiltrate into the uppers. For example, as shown in figures, the waterproof function is provided by forming the inner air passage on upper portion of the inside of the cross-linked foam for uppers and forming the outer air passage on lower portion of the outside of the cross-linked foam for uppers. An unexplained reference number 780 is an inner surface of the completed uppers.

In another aspect of the present invention, a manufacturing method for a three-dimensional cross-linked foam for uppers for shoes comprises a step of preparing foaming material (S100), a step of cross-linked foaming (S300) and a step of vacuum molding (S400).

Because a step of forming an interfacing pattern (S200) to form the inner cavity structure is omitted in the present embodiment, the number of the foaming material may not be plural. Though fore-mentioned descriptions pertaining to the inner cavity structure cannot be applied to this embodiment, the same idea and technique can be applied to this embodiment except those pertaining to the inner cavity structure.

The present embodiment may further comprise steps of processing S500, disposing S600 and re-molding S700 after the vacuum molding step S400. The same idea and technique as those mentioned in the previous embodiments can be applied to above additional steps and it will not be repeatedly described hereinafter.

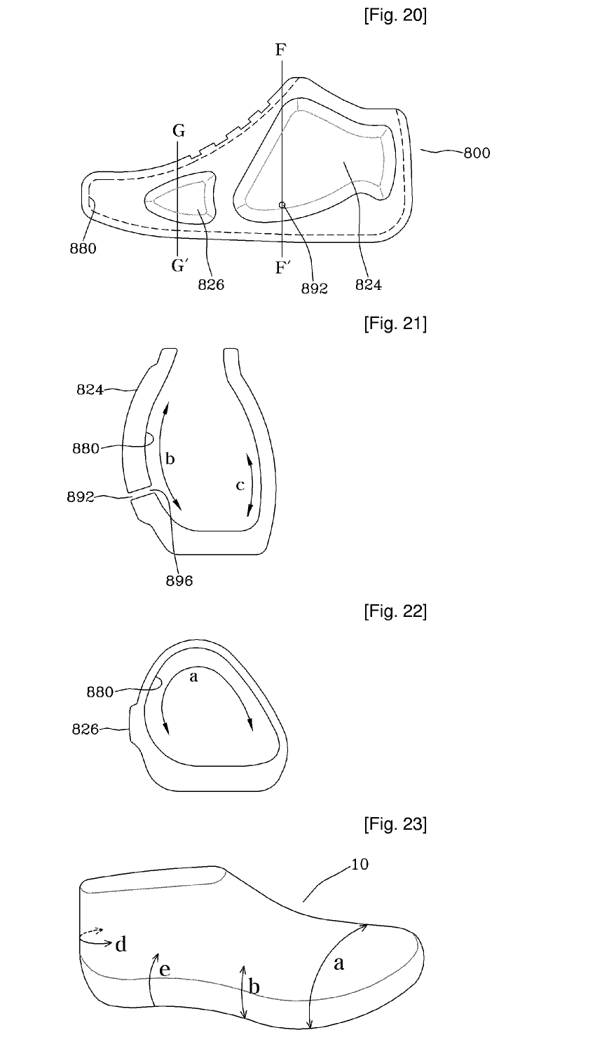

FIG. 20 is illustrating a three-dimensional cross-linked foam for uppers of shoes according to the present embodiment and FIGS. 21 to 22 are cross-sectional views of the three-dimensional cross-linked foam taken along lines F-F′ and G-G′ of FIG. 20, respectively. The three-dimensional cross-linked foam for uppers 800 is formed by a vacuum molding die. A cavity of the vacuum molding die has unevenness corresponding to projected portions 824 and 826 of the cross-linked foam 800. Air passages 892 and 896 are formed at the projected portion 824 as shown in FIG. 21. The inner surface 880 is naturally shaped after the outer curved surface of the last 10.

It will be apparent to those skilled in the art that various modifications and variations can be made in a manufacturing method of three-dimensional cross-linked foam for uppers for shoes without departing from the spirit or scope of the invention. Thus, it is intended that the present invention cover the modifications and variations of this invention provided they come within the scope of the appended claims and their equivalents.

1. A manufacturing method of three-dimensional cross-linked foam for uppers of shoes, comprising:
preparing a plurality of foaming materials in a planar or three-dimensional shape with a cross-linked foaming suppressed;
forming at least one interfacing pattern on at least one foaming material to prevent physical and chemical interactions between the foaming materials, the interfacing pattern formed of at least one interfacing material;
cross-linked foaming of the foaming material having the interfacing pattern thereon to obtain a cross-linked foam in a planar shape, the cross-linked foam having at least one inner cavity structure therein; and
vacuum molding the planar cross-linked foam in a vacuum molding die to obtain a cross-linked foam having a shape corresponding to a last, the planar cross-linked foam disposed in a cavity of the vacuum molding die, the cavity having a shape corresponding to the last.

2. A manufacturing method of three-dimensional cross-linked foam for uppers of shoes, comprising:
preparing at least one foaming material in a planar or three-dimensional shape with a cross-linked foaming suppressed;
cross-linked foaming of the foaming material to obtain a planar cross-linked foam; and
vacuum molding the planar cross-linked foam in a vacuum molding die to obtain a cross-linked foam having a shape corresponding to a last, the planar cross-linked foam disposed in a cavity of the vacuum molding die, the cavity having a shape corresponding to the last.

3. The method according to claim 1, further comprises putting the cross-linked foam into close contact with the last and processing the cross-linked foam into a shape of the last after the vacuum molding.

4. The method according to claim 1, further comprises following steps after the vacuum molding:
putting the cross-linked foam into close contact with the last and disposing the cross-linked foam and the last in a re-molding die having a cavity; and
re-molding the cross-linked foam, inner and outer surface of the re-molded cross-linked foam having shapes corresponding to an outer surface of the last and a surface of the cavity of the re-molding die, respectively.

5. The method according to claim 2, further comprises putting the cross-linked foam into close contact with the last and processing the cross-linked foam into a shape of the last after the vacuum molding.

6. The method according to claim 2, further comprises following steps after the vacuum molding:
putting the cross-linked foam into close contact with the last and disposing the cross-linked foam and the last in a re-molding die having a cavity; and
re-molding the cross-linked foam, inner and outer surface of the re-molded cross-linked foam having shapes corresponding to an outer surface of the last and a surface of the cavity of the re-molding die, respectively.

7. The method according to claim 1, wherein plural interfacing patterns are formed on the foaming material.

8. The method according to claim 7, wherein all or some of the plural interfacing patterns are connected to each other.

9. The method according to claim 7, wherein adjacent interfacing patterns among the plural interfacing patterns are connected to each other.

10. The method according to claim 1, further comprises filling at least one of the inner cavity structure with a filler, the filler selected from gas, same material as or different material from the cross-linked foam after one of the cross-linked foaming and the vacuum molding.

11. The method according to claim 3, further comprises filling at least one of the inner cavity structure with a filler, the filler selected from gas, same material as or different material from the cross-linked foam after processing the cross-linked foam.

12. The method according to claim 4, further comprises filling at least one of the inner cavity structure with a filler, the filler selected from gas, same material as or different material from the cross-linked foam after one of disposing and re-molding the cross-linked foam.

13. The method according to one of claims 10 to 12, wherein the filler is introduced into a housing and the housing is disposed in the inner cavity structure.

14. The method according to claim 1, further comprises forming at least one air passage connected to at least one inner cavity structure after one of the cross-linked foaming and the vacuum molding.

15. The method according to claim 3, further comprises forming at least one air passage connected to at least one inner cavity structure after processing the cross-linked foam.

16. The method according to claim 4, further comprises forming at least one air passage connected to at least one inner cavity structure after one of disposing and re-molding the cross-linked foam.

17. The method according to claim 2, further comprises forming at least one air passage at the cross-linked foam after one of the cross-linked foaming and the vacuum molding.

18. The method according to claim 5, further comprises forming at least one air passage at the cross-linked foam after processing the cross-linked foam.

19. The method according to claim 6, further comprises forming at least one air passage at the cross-linked foam after one of disposing and re-molding the cross-linked foam.

20. The method according to one of claims 1, 3 to 4, wherein the cavity of the vacuum molding die has a shape corresponding to one of fore-foot, middle-foot, rear-foot, inner side and outer side of the last.

21. The method according to claim 20, wherein unevenness is formed on a surface of the cavity of the vacuum molding die to form unevenness on the cross-linked foam at a position corresponding to at least one of the inner cavity structure.

22. The method according to claim 4, wherein the cavity of the re-molding die has a shape corresponding to one of fore-foot, middle-foot, rear-foot, inner side and outer side of the last.

23. The method according to claim 22, wherein unevenness is formed on a surface of the cavity of the re-molding die to form unevenness on the cross-linked foam at a position corresponding to at least one of the inner cavity structure.

24. The method according to one of claims 2, 5 to 6, wherein the cavity of the vacuum molding die has a shape corresponding to one of fore-foot, middle-foot, rear-foot, inner side and outer side of the last.

25. The method according to claim 24, wherein unevenness is formed on a surface of the cavity of the vacuum molding die to form unevenness on the cross-linked foam.

26. The method according to claim 6, wherein the cavity of the re-molding die has a shape corresponding to one of fore-foot, middle-foot, rear-foot, inner side and outer side of the last.

27. The method according to claim 26, wherein unevenness is formed on a surface of the cavity of the re-molding die to form unevenness on the cross-linked foam.

28. The method according to one of claims 1 to 6, wherein the foaming material is a thin film type foaming material having a uniform surface roughness.

29. The method according to claim 28, wherein the thin film type foaming material is obtained by processing a foaming material having a shape of a sheet or a pellet.
